(19) United States
(12) Patent Application Publication
(10) Pub. No.: US 2026/0080186 A1
(43) Pub. Date: Mar. 19, 2026

(54) SYSTEMS AND METHODS FOR EFFICIENT INFERENCE OF NEURAL NETWORK BASED MODELS

(71) Applicant: Salesforce, Inc., San Francisco, CA (US)

(72) Inventors: Yifei Ming, Palo Alto, CA (US); Xuan Phi Nguyen, Singapore (SG); Shafiq Rayhan Joty, San Jose, CA (US); Zhenmei Shi, Palo Alto, CA (US)

(21) Appl. No.: 19/043,329

(22) Filed: Jan. 31, 2025

Related U.S. Application Data
(60) Provisional application No. 63/696,226, filed on Sep. 18, 2024.

(51) Int. Cl. G06F 40/40; G06F 17/16; G06F 40/284

(52) U.S. Cl. CPC G06F 40/40; G06F 17/16; G06F 40/284

(57) ABSTRACT

Embodiments described herein provide A method for generating a response to an input context by a neural network based language model (LM) with a plurality of neural network layers, comprising: converting the input context into a plurality of tokens; generating one or more intermediate values associated with each of the plurality of tokens utilizing a subset of the plurality of neural network layers; selecting a subset of the plurality of tokens having highest associated intermediate values; and generating, based on the subset of the plurality of tokens, the response utilizing all of the plurality of neural network layers of the LM.

### CROSS REFERENCE(S)

The instant application is a nonprovisional of and claim priority under 35 U.S.C. 119 to U.S. provisional application No. 63/696,226, filed Sep. 18, 2024, which is hereby expressly incorporated by reference herein in its entirety.

### TECHNICAL FIELD

The embodiments relate generally to machine learning systems for neural network inference, and more specifically to systems and methods for efficient inference of neural network based models.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, LLMs are expensive in terms of memory and computation. A typical transformer-based LLM includes many layers of transformer decoders (e.g., 32 layers) and each of those layers requires computations for each of the input tokens in the context. For large contexts, large amounts of memory and compute resources are required.

### BRIEF DESCRIPTION OF THE DRAWINGS

FIG. 1 is a simplified diagram illustrating an accelerated LLM framework according to some embodiments.

FIG. 2 illustrates a transformer framework according to some embodiments.

FIG. 3 illustrates a multi-head attention model according to some embodiments.

FIG. 4 illustrates an attention mechanism according to some embodiments.

FIG. 5 illustrates an exemplary attention matrix according to some embodiments.

FIG. 6A is a simplified diagram illustrating a computing device implementing the accelerated LLM framework described in FIGS. 1-5, according to some embodiments.

FIG. 6B is a simplified diagram illustrating a neural network structure, according to some embodiments.

FIG. 7 is a simplified block diagram of a networked system suitable for implementing the accelerated LLM framework described in FIGS. 1-6B and other embodiments described herein.

FIG. 8 is an example logic flow diagram illustrating a method of generating a response to a context by a neural network based language model based on the framework shown in FIGS. 1-7, according to some embodiments.

FIGS. 9A-14B provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

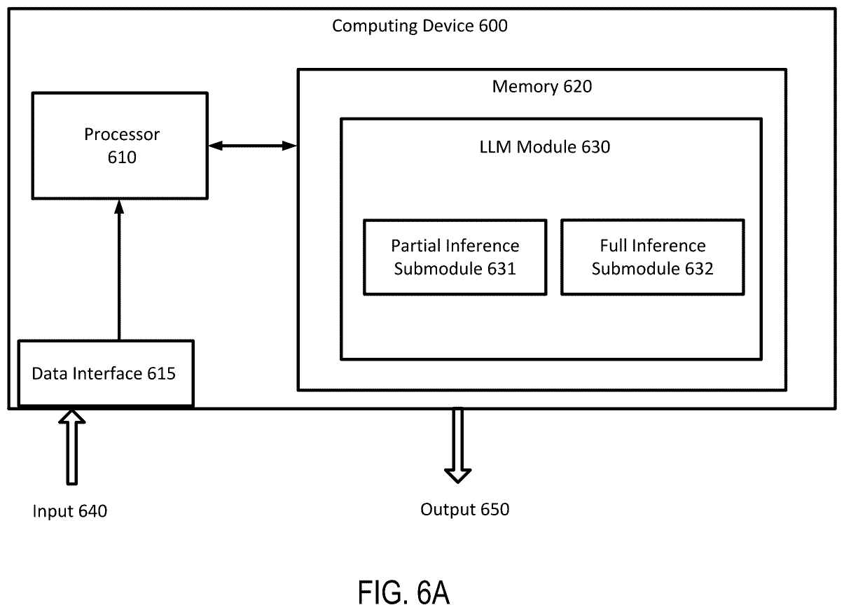

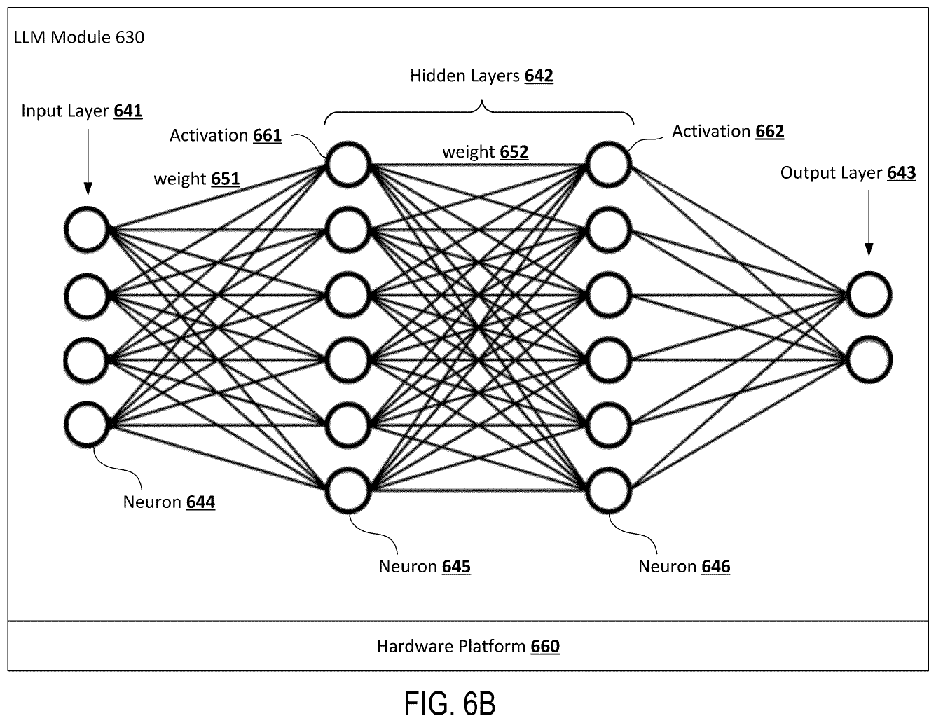

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, LLMs are expensive in terms of memory and computation. A typical transformer-based LLM includes many layers of transformer decoders (e.g., 32 layers) and each of those layers requires computations for each of the input tokens in the context. For large contexts, large amounts of memory and compute resources are required.

In view of the need for efficient methods for inference of neural network models such as LLMs, Embodiments herein provide an LLM inference framework that generates a response at reduced computational cost by performing inference on only a small subset of the input tokens (e.g., 100 out of 100,000 tokens). The subset of input tokens are selected by running only a portion of the transformer layers on the full context, and selecting the tokens receiving the most attention from the last query token. The full LLM is then run using only the selected tokens as input.

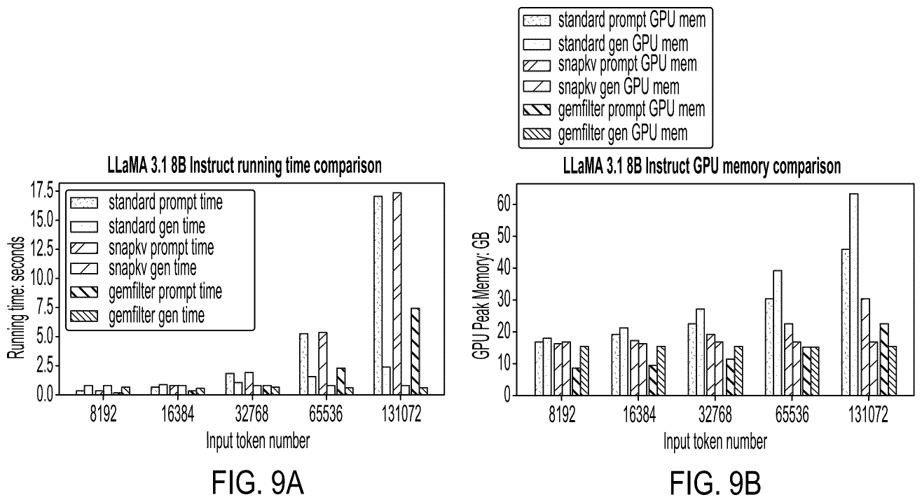

Embodiments described herein provide a number of benefits. For example, embodiments herein accelerate LLM inference and reduce GPU memory consumption. Experiments (e.g., as described in FIGS. 9A-14B) demonstrate that LLMs can identify relevant tokens in the early layers before generating answers to a query. The methods described herein using early layers of an LLM as filters to select and compress input tokens, significantly reduces the context length for subsequent processing. These methods demonstrate substantial improvements in both speed and memory efficiency compared to existing techniques. Notably, it achieves a 2.4× speedup and 30% reduction in GPU memory usage compared to SOTA methods. Evaluation on the Needle in a Haystack task shows that embodiments described herein significantly outperform standard attention, and demonstrate comparable performance on the Long-Bench challenge. Further, embodiments described herein do not require any additional training, and are broadly applicable across different LLMs. Crucially, it provides interpretability by allowing humans to inspect the selected input sequence. These findings not only offer practical benefits for LLM deployment, but also enhance understanding of LLM internal mechanisms, paving the way for further optimizations in LLM design and inference. Therefore, with improved performance on LLM efficiency, neural network technology is improved.

Examples herein are described with reference to a transformer-based LLM. In some embodiments, the acceleration methods described herein may be applied to other types of neural network architectures. For example, A neural network may include multiple layers. Internal layers of the neural network may produce intermediate values associated with the relative importance of specific inputs. By performing inference only on a first subset of layers, the intermediate values may be used to select a subset of the inputs. Full inference using all layers of the neural network may be performed using the subset of the inputs. In the example of a transformer-based LLM neural network, the layers may be decoder layers, and the intermediate values may be values in an attention matrix of one of the decoder layers.

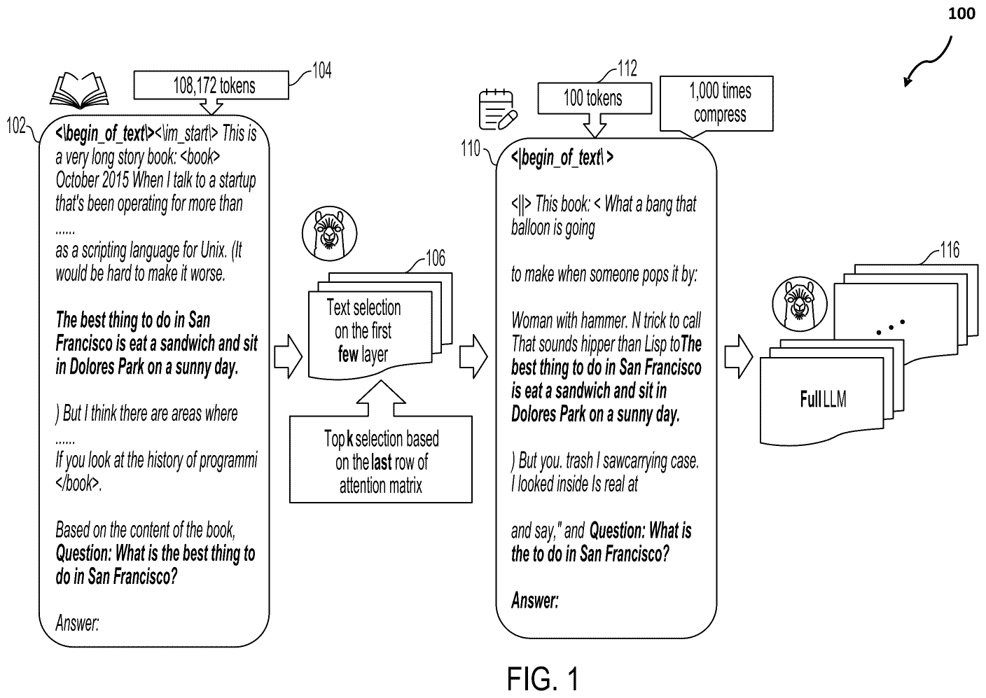

FIG. 1 is a simplified diagram illustrating an accelerated LLM framework 100 according to some embodiments. A context 102 is provided which includes (or is otherwise converted into) tokens 104. In the example, context 102 has a large number of tokens (e.g., 108,172 tokens). Tokens 104 are input to the first few layers 106 of a language model. The top k tokens are selected based on the last row of an attention matrix. Those selected tokens are illustrated as compressed context 110 including 100 tokens 112, which is approximately a 1000× reduction in the number of tokens. The smaller subset of tokens is input to the full language model 116 to generate a final output.

The example illustrated in FIG. 1 represents a “needle in a haystack” task, where LLMs must find a small piece of information within a large context. It is observed that LLMs summarize the required information in the early filter layers. As a consequence, the prompt computation only needs to be performed on a long context input for the early filter layers, allowing the input tokens to be compressed into a smaller subset (e.g., reducing from 128 K tokens to 100), saving both time and GPU memory.

Framework 100 may be utilized in a number of applications such as an LLM based AI agent. A user may utter a query in natural language. In response, a user device may output/display an answer on a display interface, such as a screen. In some embodiments, the answer is the output of language model 116 utilizing framework 100 for compressing input tokens, and language model 116 may be built on a bot server that is communicatively connected to user device. In some embodiments, the language model 116 receives query through utterance of user, which may retrieve a corpus of documents, and generate an output based on the retrieved documents.

As an example, query may include a query that includes a large text document in the context, and including after the text a query of “Based on the content of the book, Question: What is the best thing to do in San Francisco?” The AI agent may include the query in a predefined format providing instruction to the LLM how to generate a response to query, referred to as a “prompt,” which may be fed to an LLM as input. The language model 116 may in turn provide an answer.

The underlying language model 116 may be implemented at user device, or at a remote server which is accessible by the user device. The language model 116 may be trained with a large corpus of texts and/or documents to provide a user desirable response, however the framework 100 may be applied independently of the specific training scheme used in creating language model 116.

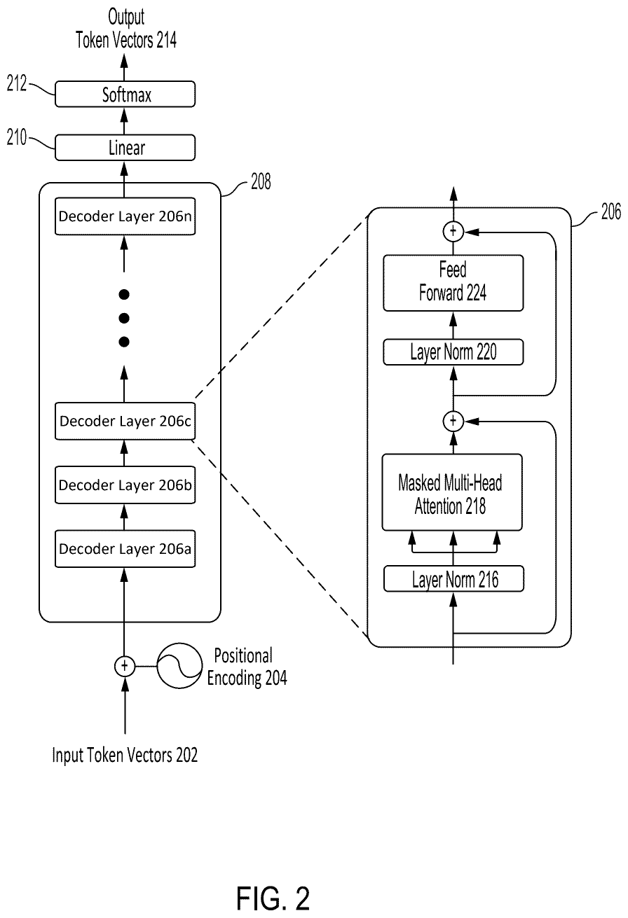

FIG. 2 illustrates a transformer framework according to some embodiments. In some embodiments, language model 116 is a LLM built at least in part including a transformer architecture as described in FIGS. 2-4. For example, the Transformer architecture comprises multiple decoder layers 206, each consisting of self-attention 218 and feedforward 224 neural networks. The self-attention layer 218 transforms a set of input tokens (such as words) into different weights assigned to each token, capturing dependencies and relationships among tokens. The feedforward layers 224 then transform the input tokens, based on the attention weights, represents a high-dimensional embedding of the tokens, capturing various linguistic features and relationships among the tokens. The self-attention 218 and feed-forward 224 operations are iteratively performed through multiple layers 206 of self-attention and feedforward layers, thereby generating an output 214 based on the context of the input tokens 202 (which may be in the form of vectors, and as there are multiple vectors concatenated that may be considered a matrix). One forward pass for an input tokens 202 to be processed through the multiple layers 206 to generate an output in a Transformer architecture often entail hundreds of teraflops (trillions of floating-point operations) of computation.

For example, the Transformer-based architecture may process an input sequence of tokens 204 (e.g., letters, symbols, numbers, signs, words, etc.) using an encoder-decoder architecture (for tasks such as machine translation, etc.) or just the encoder (for classification tasks) or decoder (for generation-only tasks) as illustrated in the example of FIG. 2. First, the input sequence may be tokenized and converted into embeddings, which are dense numerical representations, e.g., vectors of values. Positional encodings 204 are added to these embeddings to provide information about the order of tokens.

In embodiments utilizing a transformer encoder, the transformer encoder may consist of multiple layers, each of which may processes the input using a multi-head self-attention mechanism to capture relationships between tokens and a feed-forward network to transform the information, resulting in encoded representations of the input sequence of tokens.

In a decoder-only architecture as illustrated, each decoder layer 206 may include a masked multi-head attention 218 and feed forward 224. In some embodiments, normalization layers 216 and 220 may be provided before each of the multi-head attention 218 and feed forward 224 respectively. Further, residual connections may be used around the norm 216 and multi-head attention 218 and/or around layer norm 220 and feed forward 224. By feeding previous outputs back into the input, the model may be used to auto-regressively determine the next token in a sequence. The Transformer decoder 208 may generate output tokens one by one, with each step using the previously generated tokens as part of the input and updated attention weights. The Transformer decoder 208 may include a linear layer 210 and softmax function 212 to predict probabilities for the next token in the sequence, selecting the most likely one to continue the output. This process repeats until a special end token is generated or a length limit is reached.

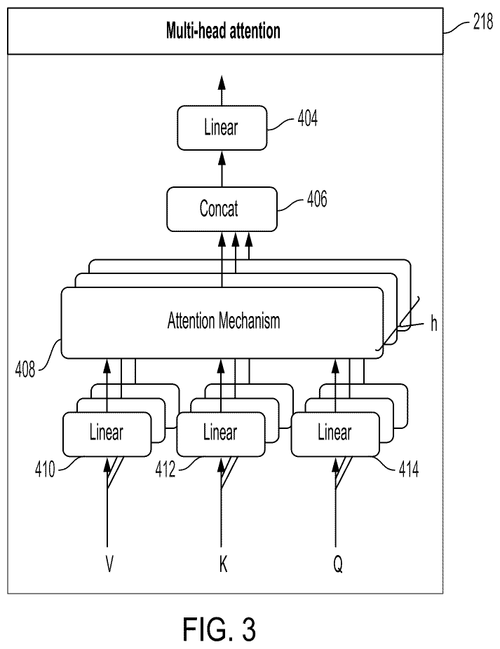

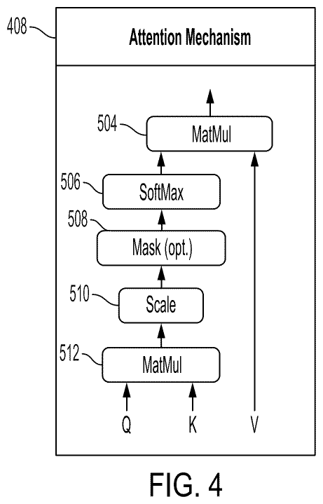

FIG. 3 illustrates a multi-head attention model according to some embodiments. The multi-head self-attention mechanism 218 at each Transformer layer within the Transformer decoder of an LLM may project input embedding matrices at the layer 206 into three different embedding spaces referred to as Query (Q) representing what a token wants to attend to, Key (K) representing what this token offers as information and Value (V) representing the actual information carried by the token. The projection of the K, Q, and V vectors is accomplished via linear layers 410, 412, and 414 respectively which include weight matrices. For multi-head attention, each of linear layers 410, 412, and 414 include multiple different weighting matrices, The Q, K, V weight matrices contain tunable weights of a Transformer-based language model that are updated during training. Then, the attention mechanism 408 computes attention scores between all tokens in the input sequence using the Q, K and V matrices (described further in FIG. 4). The resulting attention scores are then used to generate encoded representations of the input sequence of tokens. For multi-head attention, the output matrices from the multiple attention mechanisms 408 are concatenated via concatenation 406. The output vectors may be further processed via a linear projection 404.

The generated sequence of tokens may jointly represent an output. For example, a Transformer-based LLM (such as language model 116) may receive a natural language input (such as a question) and generate a natural language output (such as an answer to the question). The transformer architecture described herein is exemplary, and alternative architectures may be utilized with the methods described herein.

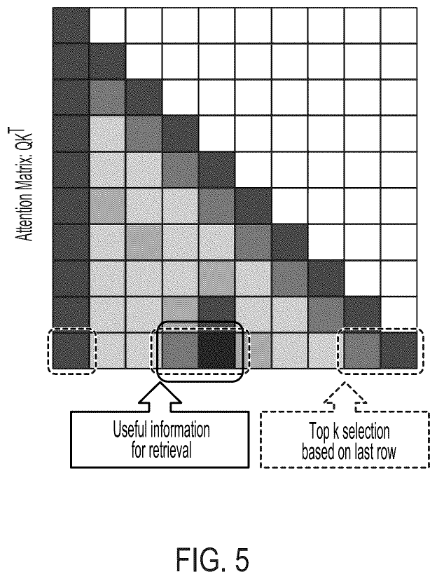

FIG. 4 illustrates an attention mechanism 408 according to some embodiments. As illustrated, the Q and K (or the transpose of K) matrices are multiplied at multiplication 512. This represents the operation of determining which tokens of K are attended to based on the tokens of query Q. The result of the multiplication maybe scaled at scale 510 (e.g., by dividing by the square root of d, where d is the size of the embedding dimension. A mask 508 may be applied to the matrix to mask out tokens that follow a given token within the sequence, thereby prohibiting looking forward in the sequence during self-attention to future tokens (i.e., causal masking). A softmax 506 may also be used on the matrix to normalize it. The output of the softmax is an attention matrix that may be considered a representation of which tokens are most important with relation to each of the other tokens in the sequence. An exemplary attention matrix is described in FIG. 5. To generate an output matrix, the attention matrix may be multiplied by the V matrix at multiplication 504.

FIG. 5 illustrates an exemplary attention matrix according to some embodiments. The attention matrix illustrated is masked as the values above the diagonal do not contain meaningful values. Each row of the attention matrix (which is the result of the QK^{T} as described in FIG. 4) represents the attention between tokens. For example, the top row represents a first token in a sequence, and since causal masking is used, it is only able to attend to itself. The bottom row represents the attention between the final token and every other token in the sequence, with the darker shades representing a stronger attention. In some embodiments, the final token is a special token (e.g., an “end of text” token). Five of the cells of the final row are illustrated as selected as being the top k (in this example k=5) tokens. According to embodiments herein, these top values of the final row of the attention matrix are utilized in selecting the most important tokens, which will therefore be the tokens used in the full inference using language model 106. For multi-head attention, multiple matrices will exist for a single decoder layer 206. The values in the final row of the attention matrices when there are multiple may be combined, for example by summing the respective values. The top k values after summing are then selected. In some embodiments, the final row of the attention matrices may be combined by selecting the maximum value for each token. For example, the final rows of two matrices may have values {1,4,3,5,4} and {1,2,5,1,4}. If summing, the result would be {2,6,8,6,8} and the top two tokens would be the third and fifth tokens. If using the max, the result would be {1,4,5,5,4} and the top two tokens would be the third and fourth tokens.

As a Transformer decoder 208 includes multiple decoder layers 206, the specific decoder layer 206 that is used for selecting the top tokens is a configurable value. For example, the 13^{th} decoder layer 206 may be utilized. In another example, the 8^{th} decoder layer 206 may be utilized. In some embodiments, the decoder layer 206 used for selecting tokens is manually configured. In some embodiments, the decoder layer 206 used for selecting tokens is automatically selected via a tuning step that performs inference using different decoder layers 206 for the partial inference step and determining the earliest decoder layer 206 that produces a sufficiently good result. The sufficiency of the result may be based on a comparison to a known good response based on a similarity metric, and the earliest decoder layer 206 which produces a value of the similarity metric above a threshold is selected as the decoder layer 206 for selecting tokens based on its attention matrix.

In some embodiments, a KV cache may be utilized. A KV cache computes and stores the key and value states used for calculating attention at each layer. For auto-regressive decoding, text output is generated one token at a time. This auto-regressive behavior repeats some operations. By caching previous K and V values, at each auto-regressive step, the model may only need to calculate the attention on the new token. The first phase is prompt computation, which involves attention computation on the long context input tokens and generating the KV cache. The second phase is iterative generation, where auto-regressive generation occurs based on the pre-computed KV cache. Embodiments described herein are compatible with the use of a KV cache. In some embodiments,

### Computer and Network Environment

FIG. 6A is a simplified diagram illustrating a computing device implementing the accelerated LLM framework described in FIGS. 1-5, according to one embodiment described herein. As shown in FIG. 6A, computing device 600 includes a processor 610 coupled to memory 620.

Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In another embodiment, processor 610 may comprise multiple microprocessors and/or memory 620 may comprise multiple registers and/or other memory elements such that processor 610 and/or memory 620 may be arranged in the form of a hardware-based neural network, as further described in FIG. 6B.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for LLM module 630 that may be used to implement and/or emulate the systems and models, and/or to implement any of the methods described further herein. LLM module 630 may receive input 640 such as an input training data (e.g., queries and responses) via the data interface 615 and generate an output 650 which may be a response to a query.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as a query, from a user via the user interface.

In some embodiments, the LLM module 630 is configured to perform accelerated neural network inference. The LLM module 630 may further include partial inference submodule 631 configured to perform partial inference (e.g., using only a subset of the neural network) to obtain intermediate values (e.g., attention scores) for selecting a subset of inputs as described herein. The LLM module 630 may further include full inference submodule 632 configured to perform full inference (e.g., using all layers of the neural network) on a subset of inputs selected via partial inference submodule 631 as described herein.

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6B is a simplified diagram illustrating the neural network structure implementing the LLM module 630 described in FIG. 6A, according to some embodiments. In some embodiments, the LLM module 630 and/or one or more of its submodules 631-632 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as a query. The number of nodes (neurons) in the input layer 641 may be determined by the dimensionality of the input data (e.g., the length of a vector of the query). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6A, the LLM module 630 receives an input 640 of a query and transforms the input into an output 650 of a response. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LLM module 630 and/or one or more of its submodules 631-632 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a transformer based LLM as described in FIGS. 2-4, and/or the like.

In one embodiment, the LLM module 630 and its submodules 631-632 may be implemented by hardware, software and/or a combination thereof. For example, the LLM module 630 and its submodules 631-632 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the LLM module 630 and its submodules 631-632 onto hardware platform 660, the neural network based modules 630 and its submodules 631-632 may be optimized for deployment by converting it to a suitable format, such as ONNX or TensorRT, to improve performance and compatibility. Next, depending on the size and workload requirements for modules 630 and its submodules 631-632, hardware types may be chosen for deployment, e.g., processing capacity, GPU memory size, and/or the like. Frameworks and drivers for the chosen hardware 660 frameworks and drivers may thus be installed, such as PyTorch, TensorFlow, or CUDA, to support the hardware platform 660. Then, weights and parameters of the LLM module 630 and its submodules 631-632 may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the LLM module 630 and its submodules 631-632 may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the LLM module 630 and its submodules 631-632 may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LLM module 630 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LLM module 630 and one or more of its submodules 631-632 may be trained by iteratively updating the underlying parameters (e.g., weights 651, 652, etc., bias parameters and/or coefficients in the activation functions 661, 662 associated with neurons) of the neural network based on a loss function. For example, during forward propagation, the training data such as queries are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding ground-truth response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based LLM module 630 and one or more of its submodules 631-632 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

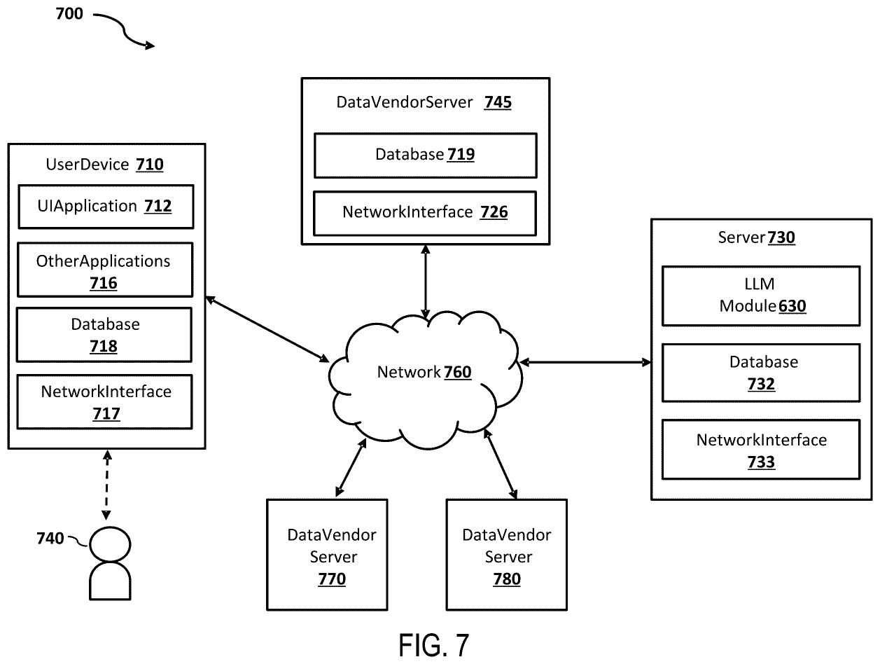

In some embodiments, LLM module 630 and its submodules 631-632 may be housed at a centralized server (e.g., computing device 600) or one or more distributed servers. For example, one or more of LLM module 630 and its submodules 631-632 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen queries which may include large contexts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology for language models, and improves the efficiency of utilizing neural networks at inference.

FIG. 7 is a simplified block diagram of a networked system 700 suitable for implementing the accelerated LLM framework described in FIGS. 1-6B and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments.

Exemplary devices and servers may include device, stand-alone, and enterprise-class servers which may be similar to the computing device 600 described in FIG. 6A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating a response from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the LLM module 630 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which LLM module 630 may generate a response via the process described in FIGS. 1-6B. The LLM module 630 may thus cause a display of a response at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view responses.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including queries and/or responses to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the LLM module 630 and its submodules described in FIG. 6A. In some implementations, LLM module 630 may receive data from database 719 at the data vendor server 745 via the network 760 to generate responses. The generated responses may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the LLM module 630. In one implementation, the database 732 may store previously generated responses, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

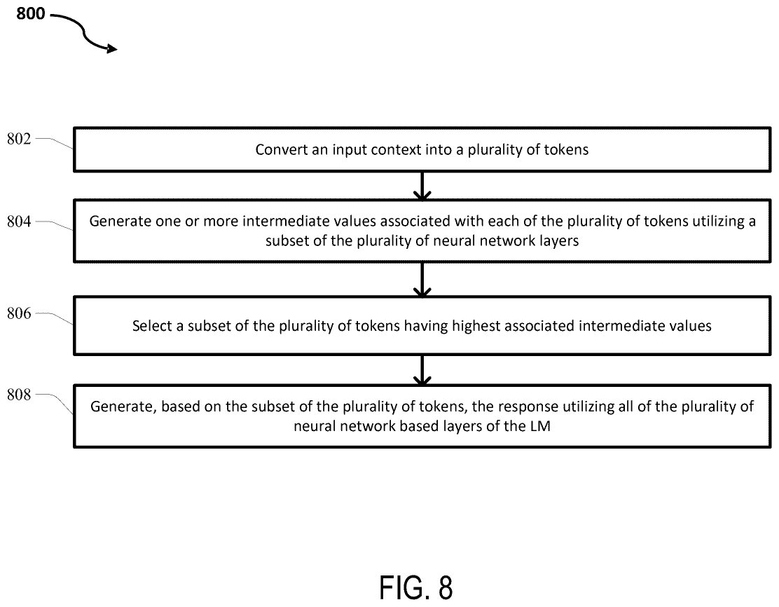

FIG. 8 is an example logic flow diagram illustrating a method of generating a response to a context by a neural network based language model based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the LLM module 630 (e.g., FIGS. 6A and 7) that performs efficient neural network inference as described herein.

In some embodiments, method 800 is performed by a system such as computing device 600, user device 710, server 730, or another device or combination of devices. Inputs (e.g., queries) may be received via a data interface such as data interface 615, network interface 717, network interface 733, or via a data interface that is integrated with a device. For example UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

Method 800 may be performed by a system with a neural network based language model (LM) (e.g., LLM 116) with a plurality of neural network layers. In some embodiments, each of the plurality of neural network layers includes a self-attention mechanism (e.g., multi-head attention 402) with a respective query matrix, a respective key matrix, and a respective value matrix.

At step 802, a system converts an input context into a plurality of tokens (e.g., tokens 202). Tokens may be vectors, and the concatenation of the vectors may be a matrix.

At step 804, the system generates one or more intermediate values associated with each of the plurality of tokens utilizing a subset of the plurality of neural network layers (e.g., decoder layers 206). In some embodiments, the intermediate values are generated by a multiplication of the respective query matrix of a last layer of the subset of the plurality of neural network layers and a transpose of the respective key matrix of the last layer of the subset of the plurality of neural network layers. In some embodiments, the intermediate values are generated by a single row (e.g., the last row, associated with the last token) of a resulting matrix from the multiplication. The self-attention mechanism may be a multi-head self-attention mechanism (e.g., multi-head attention 218). The intermediate values may be generated by combining values from each head of the multi-head self-attention. For example, combining the values may include summing the values. The intermediate values may be based on the last row of an attention matrix (e.g., as illustrated in FIG. 3) of a decoder layer (e.g., decoder layer 206).

At step 806, the system selects a subset of the plurality of tokens having highest associated intermediate values. The subset of the plurality of tokens may be sorted into the same order as in the full plurality of tokens. For example, if the plurality of tokens had tokens {A, B, C, D, E, F, G} in that order, then the subset of the plurality of tokens may be {B, C, E, G} in that order.

At step 808, the system generates, based on the subset of the plurality of tokens, the response utilizing all of the plurality of neural network layers of the LM. In some embodiments, generating the response includes sorting the subset of the plurality of tokens into a same order as in the plurality of tokens.

In some embodiments, method 800 is applicable in a variety of applications. For example, the task request received by a neural network model (e.g., LLM 116) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 800, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

FIGS. 9A-14B represent exemplary test results using embodiments described herein. Experimental results described below use the name “GemFilter” to refer to models configured to perform embodiments described herein.

FIGS. 9A and 9B show Comparison of time and GPU memory usage across different methods on LLaMA 3.1 8B Instruct. ‘gemfilter’ represents the present method, using the 13th layer as the filter. It achieves a 2.4× speedup and reduces GPU memory usage by 30% compared to SnapKV.

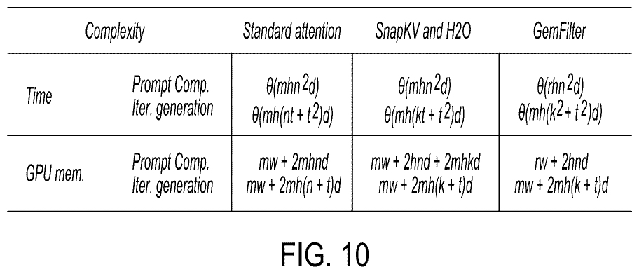

FIG. 10 shows a complexity analysis theorem. Let n be the input sequence (prompt) length and d the hidden feature dimensions. GemFilter uses the r-th layer as a filter to select k input tokens. Let SnapKV and H2O also use k as their cache size. Assume the LLM has m attention layers, each with h attention heads, and each transformer layer's parameters consume w GPU memory. Assuming that the Gen function generates t tokens and n≥max{d, k, t}, FIG. 10 summarizes the complexity for standard attention, SnapKV and H2O, and GemFilter. Recall that there are two phases in text generation. The first phase is prompt computation, which involves attention computation on the long context input tokens and generating the KV cache. The second phase is iterative generation, where auto-regressive generation occurs based on the pre-computed KV cache. Theorem 3.3 demonstrates that GemFilter is faster and consumes less GPU memory than SnapKV/H2O and standard attention during the prompt computation phase. Additionally, during the iterative generation phase, GemFilter has the same running time and GPU memory consumption as SnapKV/H2O, which is significantly better than standard attention. The running time bottleneck for all methods occurs during prompt computation, which takes Θ(mhn2d) for standard attention, SnapKV, and H2O. In contrast, GemFilter only requires Θ(rhn2d) for prompt computation, as it only processes the early layers of the LLMs to select and compress the input tokens during the first run. Note that the GPU memory bottleneck for standard attention occurs during iterative generation, while for other methods, the memory bottleneck arises during prompt computation due to the reduced KV cache. GemFilter consumes less GPU memory than SnapKV and H2O because it only requires loading some layer model weights when processing the long context input in its first run.

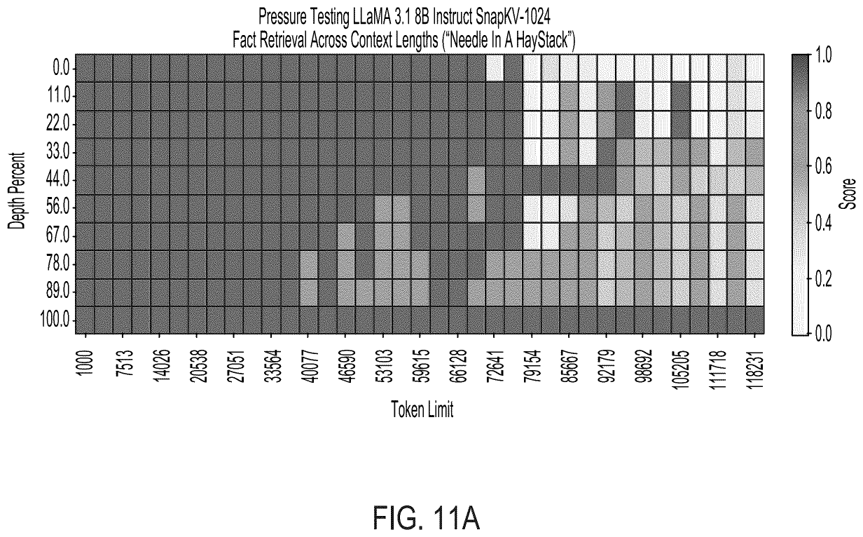

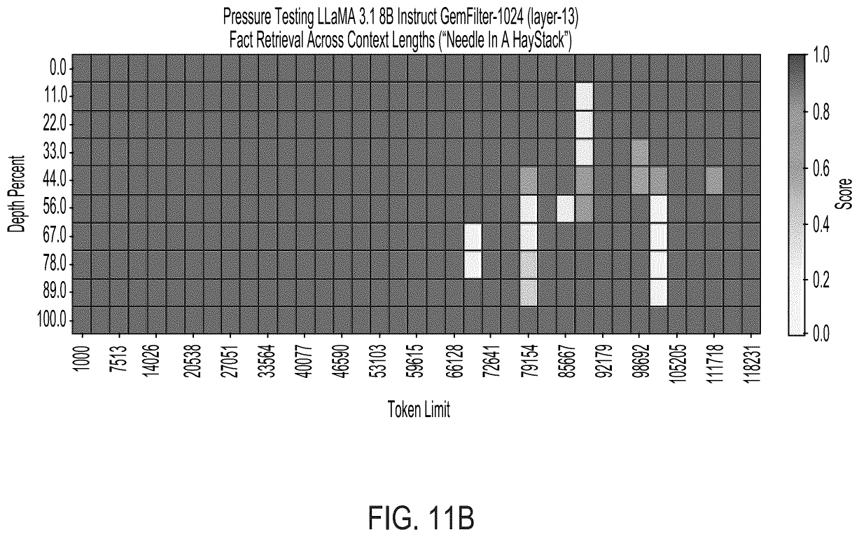

FIG. 11A shows Needle in a Haystack performance comparison of LLaMA 3.1 8B Instruct SnapKV-1024. FIG. 11B shows Needle in a Haystack performance comparison of LLaMA 3.1 8B Instruct GemFilter-1024. The x-axis represents the length of the input tokens, while the y-axis shows the position depth percentage of the ‘needle’ information (e.g., 0% indicates the beginning, and 100% indicates the end). A higher score reflects better performance, meaning more effective retrieval of the ‘needle’ information. GemFilter significantly outperforms SnapKV.

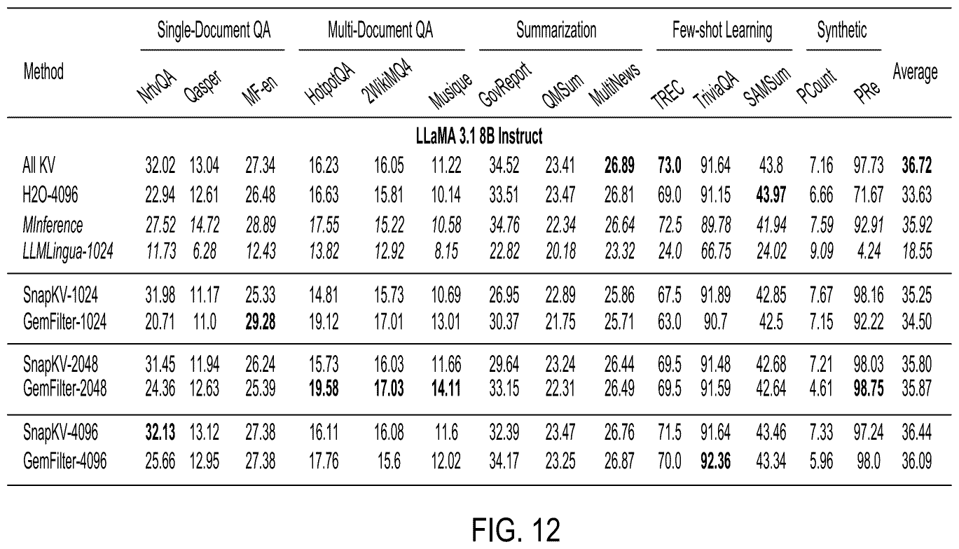

FIG. 12 shows a comparison of various methods on LLaMA 3.1 8B Instruct on LongBench where a larger number means better performance. The best score is boldfaced.

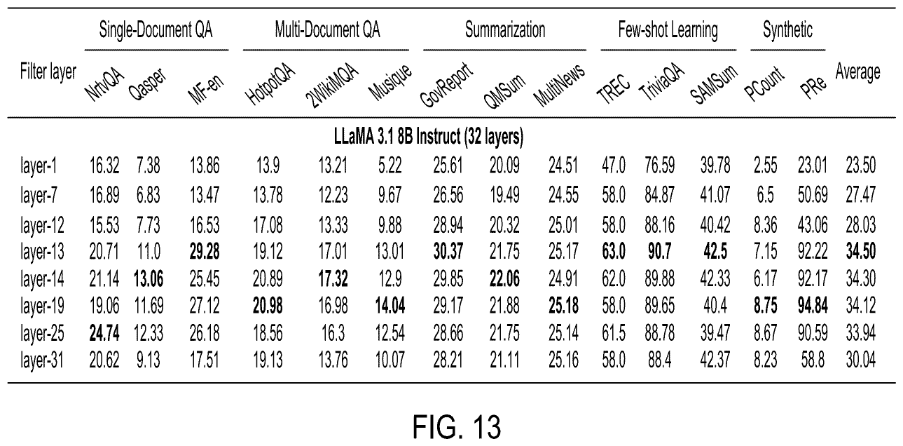

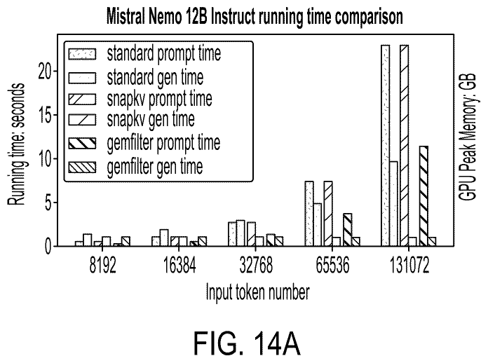

FIG. 13 shows performance of the method on LLaMA 3.1 8B Instruct, on LongBench where a larger number means better performance. The best score is boldfaced.

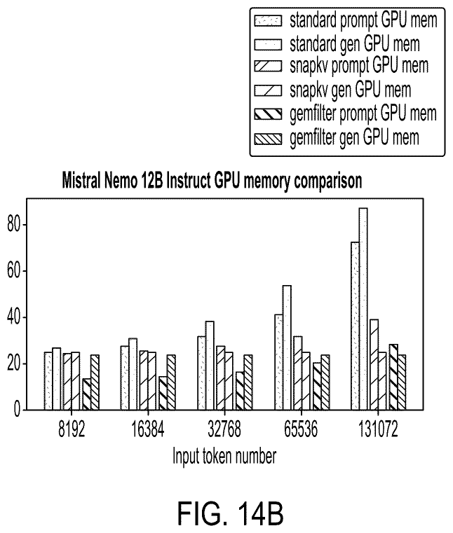

FIGS. 14A and 14B show a comparison of time and GPU memory usage across different methods on Mistral Nemo 12B Instruct and Phi 3.5 Mini 3.8B Instruct. GemFilter uses the 19th layer as an input filter. It achieves a 2.4× speedup and reduces GPU memory usage by 30% compared to SnapKV.

The approach was evaluated using three popular long-context models: LLaMA 3.1 8B Instruct, (Dubey et al., The llama 3 herd of models. arXiv preprint arXiv:2407.21783 2407.21783, 2024); Mistral Nemo 12B Instruct (Jiang et al., Mistral 7b, 2023); and Phi 3.5 Mini 3.8B Instruct (Abdin et al., Phi-3 technical report: A highly capable language model locally on your phone. arXiv preprint arXiv:2404.14219 2404.14219, 2024), all of which support an input token length of 128K. The method, GemFilter, was compared against standard attention and two state-of-the-art methods, SnapKV (Li et al., SnapKV: LLM knows what you are looking for before generation. arXiv preprint arXiv:2404.14469 2404.14469, 2024) and H2O (Zhang et al., H2o: Heavy-hitter oracle for efficient generative inference of large language models. Advances in Neural Information Processing Systems, 36, 2023.) Two popular datasets were used for experiments: Needle in a Haystack (Kamradt, Needle in a haystack-pressure testing LLMs. https://github.com/gkamradt/LLMTest_NeedleInAHaystack, 2024) and LongBench (Bai et al., Longbench: A bilingual, multitask benchmark for long context understanding. arXiv preprint arXiv:2308.14508 2308.14508, 2023).

Except in Filter Layer Choice, for context selection, the index is always used for 13 out of 32, 19 out of 40, and 19 out of 32 layers as the input filter for LLaMA 3.1, Mistral Nemo and Phi 3.5, respectively. In Filter Layer Choice, an ablation study was used for the filter layer choice.

Needle in a Haystack. The Needle in a Haystack benchmark serves as a pressure test, challenging LLMs to retrieve accurate information from a specific sentence (the ‘needle’) hidden within an extensive document (the ‘haystack’), where the sentence can appear at any arbitrary location. The difficulty increases as the length of the haystack grows. Input lengths of 60 K were used for Mistral Nemo 12B Instruct and 120K for LLaMA 3.1 8B Instruct, as these are the maximum lengths for standard attention on two A100-40GB GPUs. The KV cache size is set to 1024 for both SnapKV and GemFilter.

As shown in FIGS. 11A and B, GemFilter significantly outperforms SnapKV. The Needle in a Haystack results suggest that the method, GemFilter, achieves superior retrieval performance for long input contexts compared to SnapKV and standard attention.

LongBench. LongBench is a multi-task benchmark designed to rigorously evaluate long-context understanding capabilities across various datasets, including single and multi-document Question Answering (QA), summarization, few-shot learning, and synthetic tasks. Evaluation is of the English-only dataset, following Li et al., 2024, and Xu et al. (Think: Thinner key cache by query-driven pruning. arXiv preprint arXiv:2407.21018 2407.21018, 2024.)

As demonstrated in FIG. 12, there is a negligible performance drop in LLMs using GemFilter compared to standard attention, even with only 1024 selected tokens. In some cases, GemFilter even outperforms standard attention, such as GemFilter-2048 for Mistral Nemo 12B Instruct. For each LLM, GemFilter and SnapKV are evaluated with selected tokens/KV caches of 1024, 2048, and 4096. Standard attention (all KV cache) and H2O were evaluated with a KV cache size of 4096 on the LongBench dataset to further demonstrate the performance of GemFilter, following. In some cases, GemFilter even outperforms standard attention, such as GemFilter-2048 for Mistral Nemo 12B Instruct. It demonstrates significantly better performance than H2O and comparable performance with SnapKV. Furthermore, GemFilter effectively filters key information in long contexts, provides interpretable summaries, and compresses the input context effectively, e.g., it reduces input tokens to an average of 8% when using 1024 tokens, and 32% when using 4096, with negligible accuracy drops.

Filter Layer Choice. To determine which layer should be chosen as the input filter, one must first determine which layer of the LLM can best identify the position of the needle information. Plotting the distance between the needle's position and the selected token index across all layers in the LLM reveals three stages in the prompt computation of LLMs. In the first stage, the initial layers preprocess the input context and search for the ‘needle’. In the second stage, some early to middle layers identify the needle information. Finally, in the third stage, the LLM prepares to generate the output based on the selected tokens. The first layer that accurately identifies the needle's position is used as the input filter. In the experiments, this layer remains consistent across different inputs.

In FIG. 13, performance first increases and then decreases as input filter layer is selected from the beginning to the end. The peak performance is observed at the 13th layer, which supports the layer selection strategy. Performance remains robust between layers 13 and 25, providing flexibility in layer selection.

Running Time and GPU Memory Consumption. In this section, the running time and GPU memory consumption of different methods are compared with FlashAttention (as in Dao et al., Flashattention: Fast and memory-efficient exact attention with io-awareness. Advances in Neural Information Processing Systems, 35:16344-16359, 2022; Dao, Flashattention-2: Faster attention with better parallelism and work partitioning. arXiv preprint arXiv:2307.08691 2307.08691, 2023; and Shah et al., Flashattention-3: Fast and accurate attention with asynchrony and low-precision. arXiv preprint arXiv:2407.08608 2407.08608, 2024) support.

In FIGS. 9A-9B, the method, GemFilter, achieves a 2.4× speedup compared to SnapKV and standard attention, with 30% and 70% reductions in GPU memory usage, respectively. It saves both running time and GPU memory by processing the long input context only during the first stage, as described in Filter Layer Choice. For the latter two stages, the LLMs only need to handle compressed inputs.

FIGS. 14A-14B show a comparison of running time and GPU memory consumption for Mistral Nemo 12B Instruct and Phi 3.5 Mini 3.8B Instruct using various methods. GemFilter runs faster and uses less GPU memory than the state-of-the-art methods, as discussed above.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for generating a response to an input context by a neural network based language model (LM) with a plurality of neural network layers, comprising:
converting the input context into a plurality of tokens;
generating one or more intermediate values associated with each of the plurality of tokens utilizing a subset of the plurality of neural network layers;
selecting a subset of the plurality of tokens having highest associated intermediate values; and
generating, based on the subset of the plurality of tokens, the response utilizing all of the plurality of neural network layers of the LM.

2. The method of claim 1, wherein each of the plurality of neural network layers includes a self-attention mechanism with a respective query matrix, a respective key matrix, and a respective value matrix.

3. The method of claim 2, wherein the intermediate values are generated by a multiplication of the respective query matrix of a last layer of the subset of the plurality of neural network layers and a transpose of the respective key matrix of the last layer of the subset of the plurality of neural network layers.

4. The method of claim 3, wherein the intermediate values are generated by a single row of a resulting matrix from the multiplication.

5. The method of claim 3, wherein:
the self-attention mechanism is a multi-head self-attention mechanism, and
the intermediate values are generated by combining values from each head.

6. The method of claim 5, wherein the combining values includes summing values.

7. The method of claim 1, wherein the generating the response includes sorting the subset of the plurality of tokens into a same order as in the plurality of tokens.

8. A system for generating a response to an input context by a neural network based language model (LM) with a plurality of neural network layers, the system comprising:
a memory that stores the LM and a plurality of processor executable instructions;
a communication interface that receives the input context; and
one or more hardware processors that read and execute the plurality of processor-executable instructions from the memory to perform operations comprising:
converting the input context into a plurality of tokens;
generating one or more intermediate values associated with each of the plurality of tokens utilizing a subset of the plurality of neural network layers;
selecting a subset of the plurality of tokens having highest associated intermediate values; and
generating, based on the subset of the plurality of tokens, the response utilizing all of the plurality of neural network layers of the LM.

9. The system of claim 8, wherein each of the plurality of neural network layers includes a self-attention mechanism with a respective query matrix, a respective key matrix, and a respective value matrix.

10. The system of claim 9, wherein the intermediate values are generated by a multiplication of the respective query matrix of a last layer of the subset of the plurality of neural network layers and a transpose of the respective key matrix of the last layer of the subset of the plurality of neural network layers.

11. The system of claim 10, wherein the intermediate values are generated by a single row of a resulting matrix from the multiplication.

12. The system of claim 10, wherein:
the self-attention mechanism is a multi-head self-attention mechanism, and
the intermediate values are generated by combining values from each head.

13. The system of claim 12, wherein the combining values includes summing values.

14. The system of claim 8, wherein the generating the response includes sorting the subset of the plurality of tokens into a same order as in the plurality of tokens.

15. A non-transitory machine-readable medium comprising a plurality of machine-executable instructions which, when executed by one or more processors, are adapted to cause the one or more processors to perform operations using a neural network based language model (LM) with a plurality of neural network layers comprising:
converting an input context into a plurality of tokens;
generating one or more intermediate values associated with each of the plurality of tokens utilizing a subset of the plurality of neural network layers;
selecting a subset of the plurality of tokens having highest associated intermediate values; and
generating, based on the subset of the plurality of tokens, a response utilizing all of the plurality of neural network layers of the LM.

16. The non-transitory machine-readable medium of claim 15, wherein each of the plurality of neural network layers includes a self-attention mechanism with a respective query matrix, a respective key matrix, and a respective value matrix.

17. The non-transitory machine-readable medium of claim 16, wherein the intermediate values are generated by a multiplication of the respective query matrix of a last layer of the subset of the plurality of neural network layers and a transpose of the respective key matrix of the last layer of the subset of the plurality of neural network layers.

18. The non-transitory machine-readable medium of claim 17, wherein the intermediate values are generated by a single row of a resulting matrix from the multiplication.

19. The non-transitory machine-readable medium of claim 17, wherein:
the self-attention mechanism is a multi-head self-attention mechanism, and
the intermediate values are generated by combining values from each head.

20. The non-transitory machine-readable medium of claim 19, wherein the combining values includes summing values.
